(19) United States
(12) Patent Application Publication
(10) Pub. No.: US 2014/0019371 A1
(43) Pub. Date: Jan. 16, 2014

(54) System and Method for Foreclosure File Assessment and Acceleration

(71) Applicant: Oversite Data Services, LLC, Tampa, FL (US)

(72) Inventor: James E. Albertelli, Jacksonville, FL (US)

(73) Assignee: OVERSITE DATA SERVICES, LLC, Tampa, FL (US)

(21) Appl. No.: 13/910,580

(22) Filed: Jun. 5, 2013

Related U.S. Application Data
(60) Provisional application No. 61/656,308, filed on Jun. 6, 2012.

(51) Int. Cl. G06Q 50/18; G06Q 10/00

(52) U.S. Cl. CPC G06Q 50/18; G06Q 10/00
USPC 705/311

(57) ABSTRACT

Disclosed is a method for the electronic processing and monitoring of foreclosure litigation. The method allows users to inputted information related to a series of foreclosure cases. This inputted information is stored in a database. On-line court records are then automatically searched to gather records related to the foreclosure litigation. A comparison is made between the inputted and gathered information. Discrepancies between the two data sets can then be highlighted and corrected. The method also allows various rules to be applied to the gathered data. Based upon these rules, recommendations can be automatically generated regarding the progress of the litigation. The system allows law firms to mitigate risk on behalf of their clients and increase the speed by which foreclosure matters progress through the legal system. It also allows financial institutions, or their service providers, to have increased transparency in their active litigated loan portfolio, thereby minimizing the risk of curtailments, operating expenses and carry cost.

### RELATED APPLICATION DATA

This application claims priority to pending U.S. Provisional Application Ser. No. 61/656,308 filed on Jun. 6, 2012 and entitled “System and Method for Foreclosure File Assessment and Acceleration.” The contents of this application are fully incorporated herein for all purposes.

### TECHNICAL FIELD

This disclosure relates to a system and method for assisting lending institutions mortgage servicers, investors, and law firms with the foreclosure process. More specifically, the present disclosure relates to a system and method for tracking, managing and accelerating specific foreclosure litigation cases through the court system.

### BACKGROUND OF THE INVENTION

The backlog of foreclosure cases facing the country has been well reported. The financial collapse of 2008 caused record levels of residential and commercial foreclosures. As a result, financial institutions, law firms, and court systems throughout the country are facing large backlogs of foreclosure cases. Foreclosure cases are litigation matters that are adversarial in nature.

Various efforts have been made over the years to automate the processing of foreclosure cases. One such example is illustrated in U.S. Pat. Pub. 2008/0201190 to Compton et al. Compton discloses a system and method for the electronic processing of default foreclosure case files. The method involves electronically reviewing data records and digital images to verify the validity and accuracy of the information and signing foreclosure notices. The method increases the efficiency and reduces errors in the volume processing of case files. It also issues foreclosure notices and generates various documents related to bankruptcy proceedings, such as MFR and POC.

US Pat. Pub. 2010/0100572 to Schiller discloses a computerized legal case management system that incorporates a reconciliation feature. It also discloses a method for docketing and reporting activities related to legal cases in court.

US Pat. Pub. 2005/0086179 A1 to Mehmet discloses a system and method for managing cases. It further discloses a multi-party interconnecting system using the Internet. It has an opposing party module with multiple tools to identify and consolidate attorney and client files and to receive settlement offers and court offers.

Although these references each achieve a unique and individual objective, all suffer from drawbacks. And none of the background art discloses a computerized system which provides its servicer clients, and their retained attorneys, with the ability to track and monitor foreclosure matters throughout the foreclosure process, identify potential threats of liability to the servicer and investor, and ensure that active foreclosure cases proceed through the foreclosure process within the designated litigation timelines. This technology audits every milestone in the foreclosure process, identifies and eliminates threats of court dismissals for inactivity, identifies open discovery requiring responses, ensures that milestone data is reported to the servicer accurately, and provides a legal strategy alternative for consideration on each file.

### SUMMARY OF THE INVENTION

Disclosed is a system and method for automating the management of foreclosure cases.

The disclosed system allows financial institutions and law firms to quickly and efficiently process foreclosure cases through the court system.

The disclosed system allows financial institutions to audit litigation performance and case data as reported by its attorneys and counsel. This information is audited against official court dockets. These audits can be updated when new entries are made on the court docket.

Still yet another possible advantage of the present system is that law firms and financial institutions are advised on how a particular foreclosure case shall be most efficiently prosecuted.

One of the advantages of the present method is that it allows a large number of foreclosure cases to be continuously monitored and audited for data integrity so that the financial institution is advised on how a particular foreclosure case shall be most efficiently prosecuted.

The disclosed method is a legal intelligence tool, which provides its servicer clients, and their retained attorneys, with the ability to track and monitor foreclosure matters throughout the foreclosure process, identify potential threats of liability to the servicer and investor, and ensure that active foreclosure cases proceed through the foreclosure process within the designated litigation timelines. This technology audits every milestone in the foreclosure process, identifies and eliminates threats of court dismissals for inactivity, identifies open discovery requiring responses, ensures that milestone data is reported to the servicer accurately, and provides a legal strategy alternative for consideration on each file. In doing this, the method provides transparency, risk mitigation, and reduces loss severity.

Various embodiments of the invention may have none, some, or all of these advantages. Other technical advantages of the present invention will be readily apparent to one skilled in the art.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a flow chart illustrating an overview of the steps carried out in the disclosed method.

FIG. 2 is the first part of a flow chart illustrating one possible implementation of the disclosed method.

FIG. 3 is the second part of a flow chart illustrating one possible implementation of the disclosed method.

FIG. 4 is the third part of a flow chart illustrating one possible implementation of the disclosed method.

FIG. 5 is the fourth part of a flow chart illustrating one possible implementation of the disclosed method.

FIG. 6 is the fifth part of a flow chart illustrating one possible implementation of the disclosed method.

FIG. 7 is the sixth part of a flow chart illustrating one possible implementation of the disclosed method.

FIG. 8 is a flow chart illustrating another implementation of the present disclosure.

### DETAILED DESCRIPTION OF THE DRAWINGS

The present disclosure relates to a method for the electronic processing, auditing, and monitoring of foreclosure litigation. The method allows users to inputted information related to a series of foreclosure cases. This inputted information is stored in a database. On-line court records are then automatically searched to gather records related to the foreclosure litigation. A comparison is made between the inputted and gathered information. Discrepancies between the two data sets can then be highlighted and corrected. The method also allows various rules to be applied to the gathered data. Based upon these rules, recommendations can be automatically generated regarding the progress of the litigation. The system allows financial institutions and law firms to increase the speed by which foreclosure matters progress through the legal system. The various components of the present invention, and the manner in which they interrelate, are described in greater detail hereinafter.

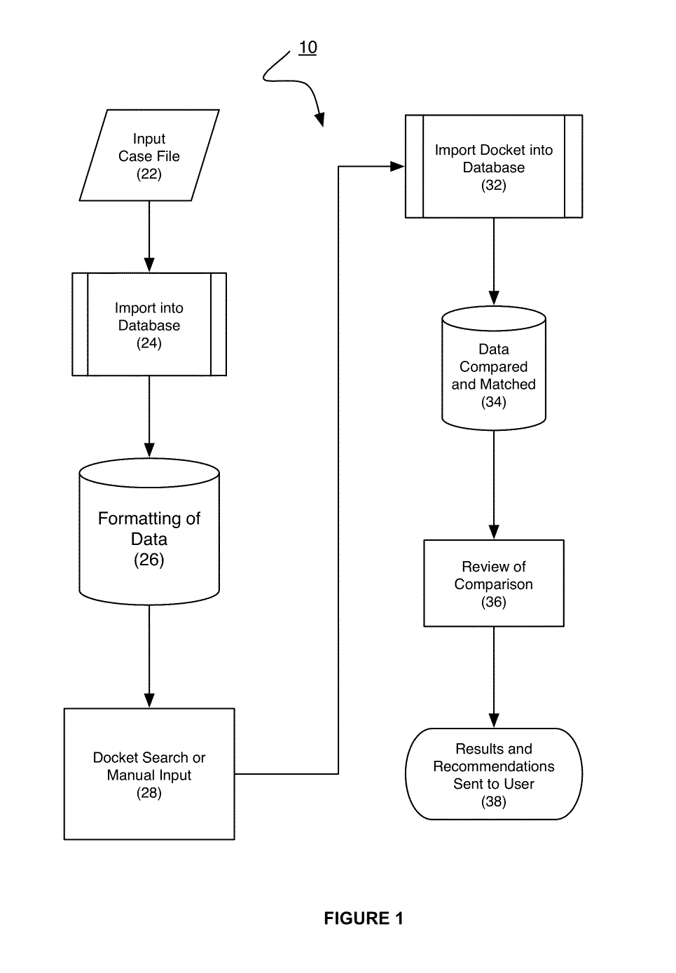

FIG. 1 is a flow chart depicting the general steps associated with the present method 20. The method is designed to be carried out by a system that may include one or more computers or servers that are interconnected to one another over a computer network. This network may be the Internet or a large or small scale network. In the first step 22, various information related to a specific foreclosure matter is obtained by the user. At step 24, this data is entered into the database. This information may be manually entered. It is also within the scope of the present invention for this information to be collected by electronically scanning paper documents and automatically entering it into the database. The information can be imported via SQL Server Integration Services (SSIS). In either event, the data inputted at this step largely represents the information in the possession of an attorney, law firm, or lending institution.

Any of a variety of data fields can be populated. By way of example, the inputted data may include, but is not limited to, the parties to the litigation, the court docket number, the attorney docket number, the filing date of the complaint, the service date of the complaint, the dates of any upcoming hearings, the dates upon which any judgment may have been entered, the dates of any foreclosure sales. The data may further include a computation of the time periods that have elapsed since the filing of the complaint, the service of the complaint, and the entry of any judgment. Likewise, the system may compute the timing remaining to any upcoming events, such as a court ordered sale or any hearings. The system may further determine whether the case has been dormant and, if so, how long it has been dormant. All of this information is either inputted into the database or computed by the system. At step 26, the data within the database is preferably formatted in a markup language, such as HTML or XML, to facilitate the display of the data.

At step 28 the system searches the Internet for any on-line court dockets relating to any of the litigation matters within the database. This step may be automated via the use of Internet bots or web crawlers. Once a relevant foreclosure litigation docket is located, information is gleaned from the on-line court docket. Certain portions of the docket information may need to be manually reviewed prior to it being inserted into the database. It may also be necessary to manually enter any docket information that is not accessible on-line. Preferably, as much data as possible will be gathered electronically.

The data fields populated at step 28 should match the data fields inputted at step 24. The gathered data may include, but is not limited to, the parties to the litigation, the court docket number, the attorney docket number, the filing date of the complaint, the service date of the complaint, the dates of any upcoming hearings, the dates upon which any judgment may have been entered, the dates of any foreclosure sales. In a manner similar to step 24, the system will likewise compute any relevant time periods, such as the number of days since the filing of the complaint, the service of the complaint, or the number of days a particular motion has been pending. The number of days remaining to any upcoming events (such as hearings or foreclosure sales) is likewise computed. All of the gathered data is entered into the database at step 34. If needed, the gathered data may be formatted to match the data inputted at step 24.

At step 34 the system automatically compares the inputted data relative to the gathered data. This comparison can be carried out by a module or subroutine in one of the computer servers on the network. In most instances, it is anticipated that this comparison will validate the information inputted by the user. That is, the information in the possession of the attorney, law firm, or financial institution will match that data gathered from the on-line courthouse records. Nonetheless, any differences between the two data sets will be highlighted. The user will be altered to any discrepancies. At step 36 the user can then determine which data set is correct and update the database accordingly. An attorney or other legal professional may perform a manual comparison of the differences between the existing data and the data obtained from the docket. It is also within the scope of the present invention to automate step 36. This could be accomplished by indicating that any discrepancies are to be corrected by deferring to the data from the courthouse docket. The foreclosure litigation can also be monitored by repeating this comparison at given intervals of time.

At step 38 the system can automatically generate a series of recommendations to the user based upon the data. The recommendations can be generated by a module or subroutine in one of the computer servers on the network. This recommendation can be made to the user, such as an attorney, law firm, or financial institution. This is accomplished by storing within the system a series of rules related to foreclosure litigation. These rules may be the applicable civil procedure rules. Different rule sets can be maintained for different jurisdictions or different user requirements. An example of some of these rules may be: that a case can be dismissed for lack of prosecution if no filings are made within 180 days; that a defendant has 20 days after service in which to answer a complaint; that discovery responses are due 30 days after service. Based upon these rules, the system can automatically generate recommendations for the user. These recommendations may include whether to file for a default judgment, a motion to dismiss for lack of prosecution, a motion to compel, or to set a case for trial. Recommendations can be automatically generated at given intervals over a period of time.

It is also possible for the system to store information relating to how quickly a foreclosure case should progress. If any particular milestones are not achieved within the designated time frame, the user can be alerted. For instance, the user could be alerted if a motion for summary judgment is not filed by a certain number of days following service of the complaint. A further alert could be generated if discovery is not received by a set number of days into the case. A dollar value can be associated with this delay. For example, the system could assign a set value of $70.00 for each day the case is delayed. This analysis would help the financial institution or law firm better prioritize their case load and would help them quantify the cost of delayed prosecution. Some rules for providing recommendations are provided below as examples:

### Securing Defaults and Final Judgments

Florida Rule of Civic Procedure §1.500 (or other applicable state rule)
Well established legal procedure
Used when no response is filed by the borrower
Does NOT LIMIT the ability to pursue deficiency or waive deficiency Judgment Fla. Stat. §702.065 (or other applicable state statute)

### Direct to Trial

Shortens timelines by requesting discovery with the initial service
Admissions are sent with or close to complaint
Borrower has 45 days to respond to the admissions before deemed admitted
The case is ready for trial as soon as discovery is complete
Does NOT LIMIT the ability to purse deficiency

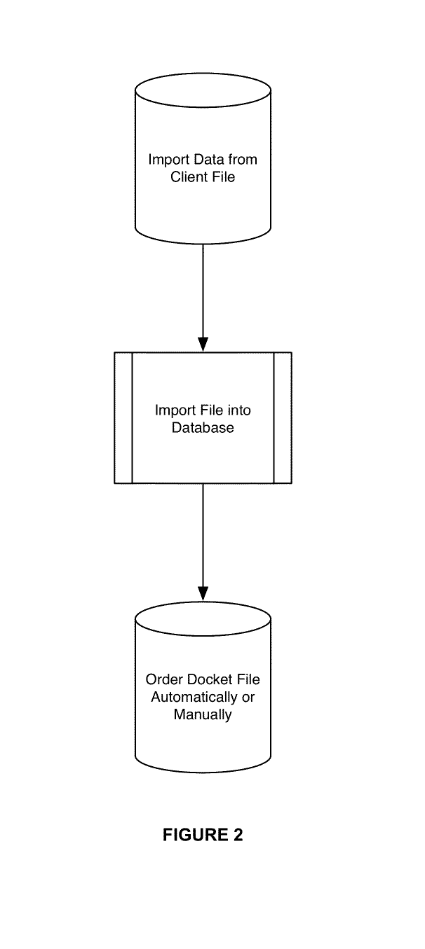

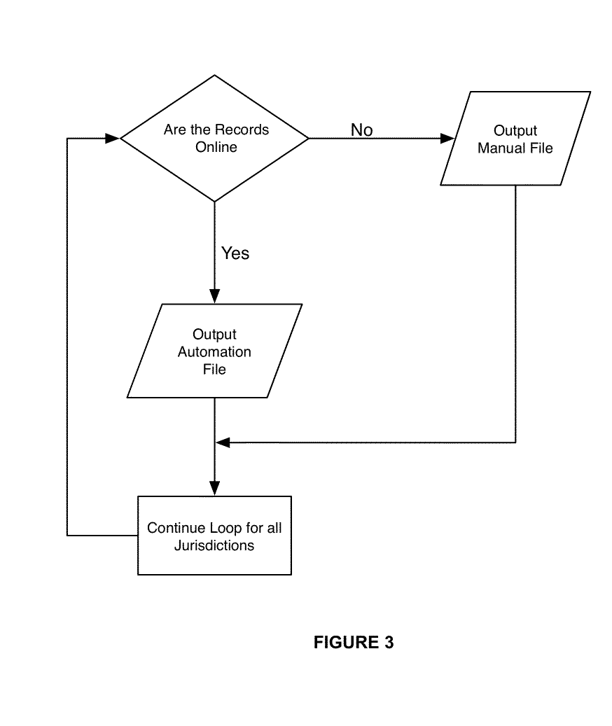

FIGS. 2-7 are more detailed flow charts illustrating some non-limiting examples of how the inventive method could be carried out. For example, FIG. 2 illustrates the steps whereby specific data elements are inputted into the database and online dockets are ordered or obtained. This can be accomplished via server import services (“SSIS”). The data imported at this step is typically generated from a client file. It can be transferred from a law firm via secure FTP. It could also be sent in an Excel spreadsheet via an encrypted email. FIG. 3 is a process loop demonstrating how online dockets are obtained. Alternatively, if the dockets are not on-line, FIG. 3 illustrates how the docket is manually obtained.

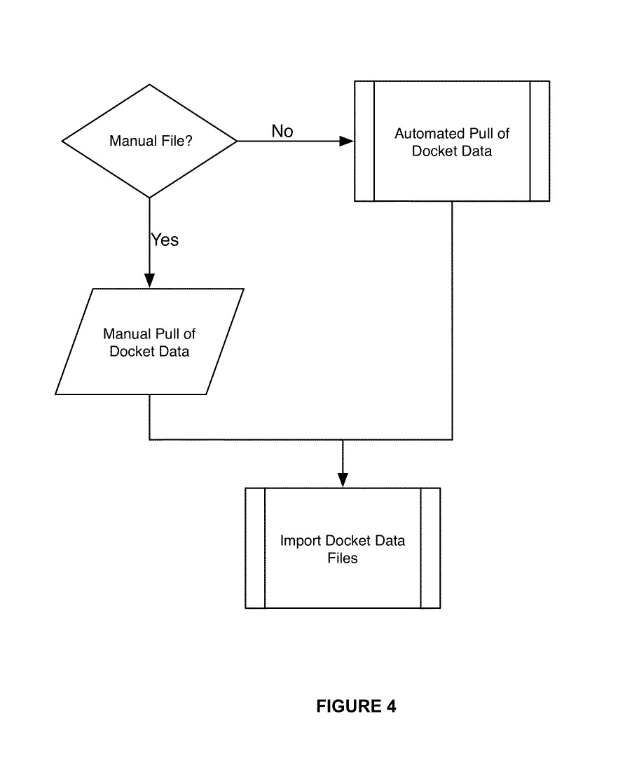

In FIG. 4, either the automated or the manually pulled dockets are imported into the database. The import file is the same layout, regardless of origin. It is an XML file and is placed on the secure FTP site. From there the file is imported into the database via SQL Server Import Services (SSIS).

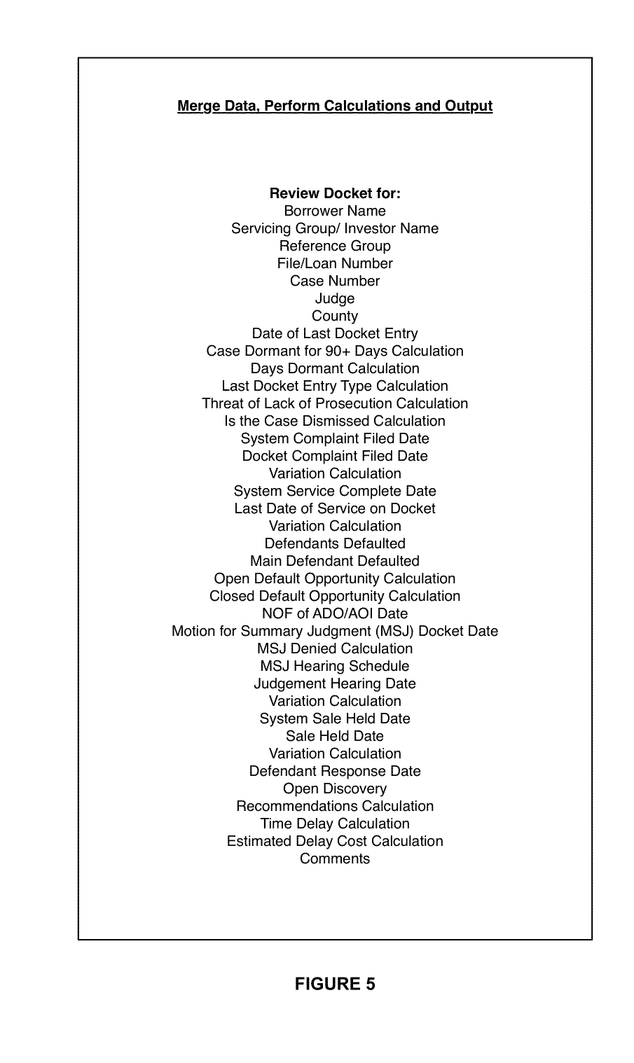

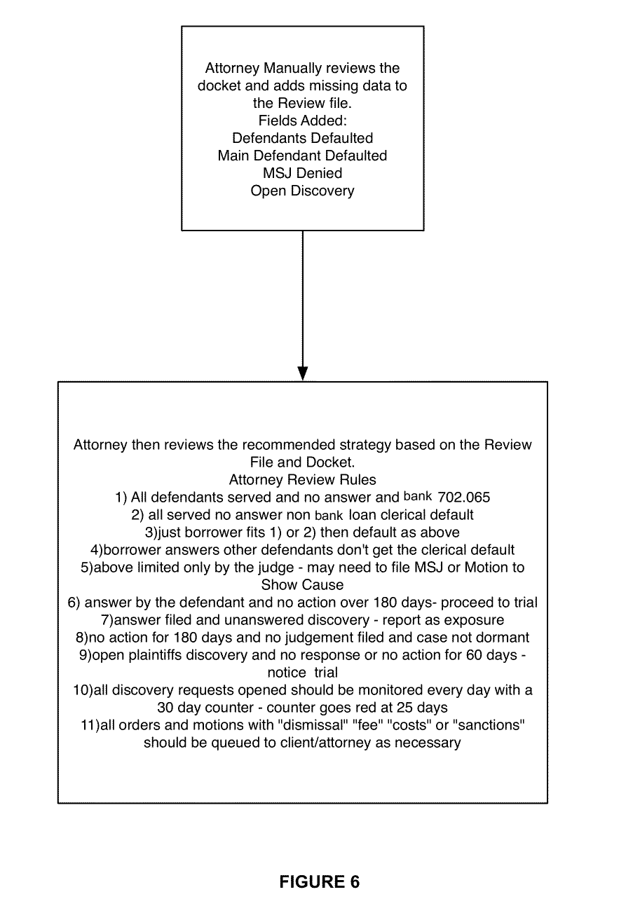

In FIG. 5, a data merge is performed, calculations are performed and outputted into spreadsheet format, such as XLSX. The calculations performed can be any of the system calculations detailed below in Table 1 or outlined in FIG. 5. Next, FIG. 6 illustrates the steps involved in an attorney or other professional reviewing the docket. This review can be performed in accordance with the attorney review rules outlined in Table 2. The Review file is a standard layout and provided to the attorney with all of the collected data, and 16 calculated fields. These calculated fields are what the attorney uses to make decisions in the case, and ensure the most appropriate strategy is utilized. The attorney will also fill in several fields after reviewing the docket. The file is produced in an Excel format.

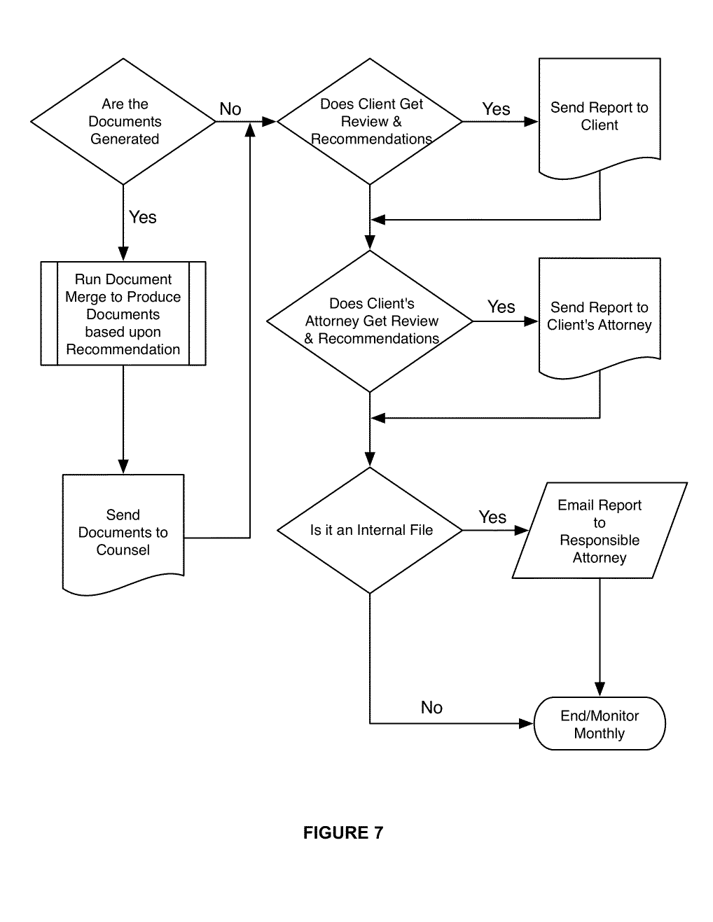

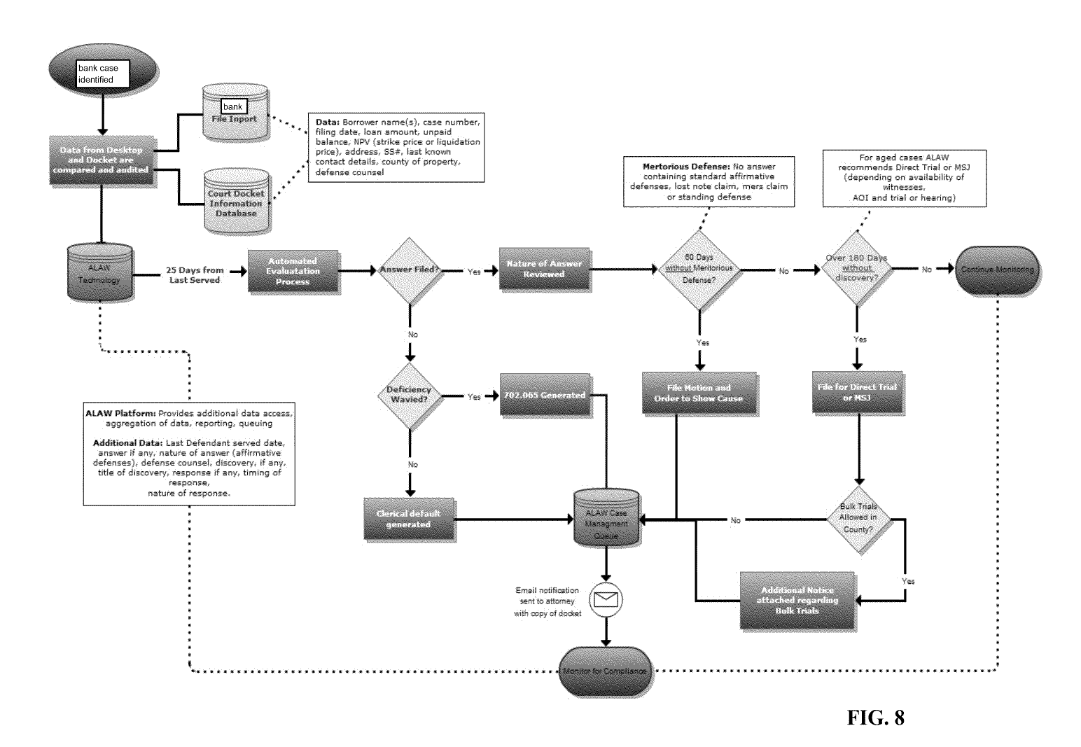

These rules may vary depending upon the particular jurisdiction in which the foreclosure matter is pending or particular user requirements. Finally, in FIG. 7, documents and reports may be generated and sent to the client depending upon the results of the calculations and the attorney review process. FIG. 8 is a flow chart illustrating an additional implementation of the system and method of the present disclosure.

It will be understood by those of ordinary skill in the art that the flow charts depicted herein are intended to be carried out via one or more computer software programs. The computer programs are embodied in a tangible medium of expression with one or more lines of computer code embedded upon the medium. The computer code may be object code or source code. It may be written in one or more programming languages, such an Java, Perl, C++, or similar programming languages. The program may be executed entirely on a user computer, entirely on a computer server, or it may be executed partly on a user computer and partly on a computer server.

The disclosed system is designed to be employed over a computer network. The computer network may include, for example, a central computer, which may be a server or a cluster of computers, that is in communication with a number of client computers via the network. It is understood that any number of client computers can be employed depending upon the nature of the network. The central and client computers can be, for example, servers, computer clusters, server pools, general-purpose personal computers, workstations, laptops, net books, personal digital assistants (PDAs), or cellular telephones. The term “computer” as used herein encompasses all of these various computing devices.

TABLE 1
Examples of System Calculations

| Column Title | Developer Definition |
|---|---|
| Case Dormant for | =IF([Days Dormant]=“”,“”,IF([Days Dormant]>90,“Yes”,“No”)) |
| 90+ Days | |
| Days Dormant | =IF([Date of Last Docket Entry]=“”,“”,TODAY( )−[Date of Last Docket Entry]) |
| Threat of Lack of | =IF([Days Dormant]=“”,“”,IF([Days Dormant]>180,“Yes”,“No”)) |
| Prosecution (Case | |
| Dormant for 180+ | |
| Days or FWOP | |
| Notice Generated) | |
| Complaint Variation | =IF([Docket Complaint Filed Date]=“”,“”,IF([BANK Complaint Filed |
| (+/−) | Date]=“”,“”,[Docket Complaint Filed Date]−[BANK Complaint Filed Date])) |
| Service Complete | =IF([Last Date of Service on Docket]=“”,“”,IF([BANK Service Complete]=“”,“”,[Last |
| Variation (+/−) | Date of Service on Docket]−[BANK Service Complete])) |
| Open Default | =IF([Last Date of Service on Docket]=“”,“No”,IF(AND([Defendant Response |
| Opportunity | Date]=“”,([Last Date of Service on Docket]+25)<TODAY( )),“Yes”, “No”)) |
| Closed Default | =IF(AND([Open Default Opportunity]=“No”,([Defendant Response Date]−[Last |
| Opportunity | Date of Service on Docket])>25),“Yes”, “No”) |
| Hearing Scheduled | =IF([BANK Judgement Hearing Scheduled For]=“1/1/1950”,“Error”,IF([Judgement |
| Variation (+/−) | Hearing Date]=“”,“”,IF([BANK Judgement Hearing Scheduled |
| | For]=“”,“”,[Judgement Hearing Date]−[BANK Judgement Hearing Scheduled |
| | For]))) |
| Judgment Entered | =IF([Judgement Entered Date]=“”,“”,IF([BANK Judgement |
| Variation (+/−) | Entered]=“”,“”,[Judgement Entered Date]−[BANK Judgement Entered])) |
| Sale Scheduled | =IF([Sale Scheduled Date]=“”,“”,IF([BANK Sale Scheduled For]=“”,“”,[Sale |
| Variation (+/−) | Scheduled Date]−[BANK Sale Scheduled For])) |
| Sale Held Variation | =IF([BANK Sale Held]=“”,“”,IF([Sale Held Date]=“”,“”,IF([BANK Sale |
| (+/−) | Held]=“”,“”,[Sale Held Date]−[BANK Sale Held]))) |
| Recommendations | =IF([Open Default Opportunity]=“Yes”,“Default”,IF(AND([Case Dormant for 90+ |
| | Days]=“Yes”,[0pen Default Opportunity]=“No”),“Trial”,“MSJ”)) |
| Time Delay | =IF([Is Case Dismissed]=“Yes”,[=(TODAY( )−[Last Date on Service Docket])− |
| | (295+71)],IF([Recommendations]=“Trial”,[=(TODAY( )−[Last Date on Service |
| | Docket])−(295+71)],IF(OR([Open Default Opportunity]=“Yes”,[Closed Default |
| | Opportunity]=“Yes”),IF([=IF([Sale Held Date]<>“”,[Sale Held Date],IF([Sale |
| | Scheduled Date]<>“”,[Sale Scheduled Date],IF([Judgment Entered |
| | Date]<>“”,[Judgment Entered Date],“”)))]<>“”,([=IF([Sale Held Date]<>“”,[Sale |
| | Held Date],IF([Sale Scheduled Date]<>“”,[Sale Scheduled Date],IF([Judgment |
| | Entered Date]<>“”,[Judgment Entered Date],“”)))]−[Docket Complaint Filed |
| | Date])−186,“”),“”))) |
| Estimated Delay | =IF([Time Delay]=“”,“”,[Time Delay]*70) |
| Cost at $70 Per Day | |

TABLE 2
Attorney Review Rules

| Rule | Rule Description |
|---|---|
| 1 | All defendants served and no answer and Bank - 702.065 |
| 2 | All served no answer non Bank loan - Clerical Default; |
| 3 | Just borrower fits one or two default them as above; |
| 4 | Borrower answers other defendant or defendants don't get the clerical default; |
| 5 | Above limited only by judge who won't follow law result do - Motion And Order To Show |
| | Cause or MSJ based on county preference (from spreadsheet) |
| 5 | Answer filed by Defendant (borrower) and NO action for 60 days (case under 180) - Direct |
| | Trial (unless matrix says MSJ); |
| 6 | Answer by Defendant (Borrower) and no action over 180 - Direct Trial; |
| 7 | Answer filed and discovery propounded by Defense Counsel and no response for more than |
| | 30 days report as exposure and if no case action for 90 days, - Direct Trial Opportunity |
| 8 | Any case no action for 180 days and no judgment filed and no hold - Dormant Case; |
| 9 | Open plaintiffs discovery and no response and no action for 60 days - Notice To Trial |
| 10 | All discovery requests opened should be monitored every day with a 30 day counter which |
| | should go red at day 25 and stay red until answered; |
| 11 | All orders and motions with ‘dismissal’ ‘compel’ ‘fees’ ‘costs’ ‘sanctions’ should be queued to |
| | BA and then attorney, as necessary |

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A method for the electronic processing and monitoring of foreclosure litigation, the method utilizing a computer network and a database, the method comprising the following steps:
inputting data relative to a specific foreclosure litigation, the inputted data including the parties to the litigation, the docket number, the filing date of the complaint, the service date or dates of the complaint, the dates of any hearings, the entry date of any judgment, the date of any foreclosure sale, and whether the case has been dormant for a period of time, the inputted data being imported into the database;
formatting the inputted data into an XML format;
searching the computer network for on-line court dockets for the specific foreclosure litigation and gathering data regarding the foreclosure litigation, the gathered data including the parties to the litigation, the docket number, the filing date of the complaint, the service date of the complaint, the dates of any hearings, the entry date of any judgment, the date of any foreclosure sale, and whether the case has been dormant for a period of time, the gathered data being imported into the database;
storing a series of rules related to foreclosure litigation, the rules including the relevant time periods for filing a motion for default and motion to dismiss for lack of prosecution;
automatically comparing the inputted data relative to the gathered data, highlighting any differences between the inputted and gathered data, updating the database as a result of the comparison;
automatically generating a litigation recommendation by applying the rules to the updated data, the litigation recommendations comprising filing for a default judgment, filing a motion for summary judgment, filing a motion to show cause, responding to open discovery, or proceeding to trial.

2. A method for the electronic processing and monitoring of foreclosure litigation, the method comprising the following steps:
inputting data relative to a specific foreclosure litigation, the inputted data being imported into the database;
searching a computer network for on-line court dockets for the specific foreclosure litigation and gathering data regarding the foreclosure litigation, the gathered data being imported into the database;
automatically comparing the inputted data relative to the gathered data, visually highlighting any differences between the inputted and gathered data.

3. The method as described in claim 2 comprising the further step of updating the database as a result of the comparison.

4. The method as described in claim 2 wherein the inputted data includes the docket number, the filing date of the complaint and the service date of the complaint.

5. The method as described in claim 2 wherein the inputted data includes the dates of any hearings, the entry date of any judgment, the date of any foreclosure sale, and whether the case has been dormant for a period of time.

6. The method as described in claim 2 wherein the gathered data includes the docket number, the filing date of the complaint, and the service date of the complaint.

7. The method as described in claim 2 wherein the gathered data includes the dates of any hearings, the entry date of any judgment, the date of any foreclosure sale, and whether the case has been dormant for a period of time.

8. The method as described in claim 2 comprising the further step of storing a series of rules related to foreclosure litigation, the rules including the relevant time periods for filing a motion for default and motion to dismiss for lack of prosecution.

9. The method as described in claim 8 comprising the further step of automatically generating recommendations by applying the rules to the updated data, the recommendations including whether to file for a default judgment or to file a motion to dismiss for lack of prosecution.

10. The method as described in claim 2 comprising the further steps of storing data related to the timing of certain filings in the foreclosure litigation and computing the number of days by which these filings are delayed.

11. The method as described in claim 10 comprising the further step of assigning a dollar value to the delayed filings.

12. A system for the electronic processing and monitoring of foreclosure litigation, the system comprising:
a series of computers communicating with one another over a network;
a database connected to the network;
the database containing manual data relative to a specific foreclosure litigation;
the database further including on-line data from court dockets for the specific foreclosure litigation;
one of the computers containing a module for automatically comparing the manual data to the on-line data and generating a report of any differences between the manual and on-line data.

13. The method as described in claim 9 comprising the further step of monitoring foreclosure litigation by generating a series of recommendations over a specific time interval.

14. The method as described in claim 2 comprising the further step of monitoring the foreclosure litigation by repeatedly comparing the inputted data relative to the gathered data at regular intervals over a specific time period.
